(19) United States
(12) Patent Application Publication
(10) Pub. No.: US 2003/0164819 A1
(43) Pub. Date: Sep. 4, 2003

(54) Portable object identification and translation system

(76) Inventor: Alex Waibel, Pittsburgh, PA (US)

Correspondence Address: THORP REED & ARMSTRONG, LLP, ONE OXFORD CENTRE, 301 GRANT STREET, 14TH FLOOR, PITTSBURGH, PA, 15219-1425, US

(21) Appl. No.: 10/090,559

(22) Filed: Mar. 4, 2002

(51) Int. Cl. G09G 5/00

(52) U.S. Cl. 345/173; 345/179

(57) ABSTRACT

A portable information system is comprised of an input device for capturing an image having a user-selected object or text, and a background. A hand-held computer is responsive to the input device and is programmed to: distinguish the user-selected object/text from the background; compare the user-selected object to a database of objects/characters; and output a translation of, information about, or interpretation of, the user-selected object or text in response to the step of comparing. The invention is particularly useful as a portable aid for translating or remembering text messages foreign to the user that are found in visual scenes. A second important use is to provide mobile information and guidance to the mobile user in connection with surrounding objects (such as, identifying landmarks, people, and/or acting as a navigational aid). Methods of operating the present invention are also disclosed.

### FIELD OF THE INVENTION

The present invention relates generally to object identification and translation systems and more particularly to a portable system for capturing an image, extracting an object or text from within the image, identifying the object or text, and providing information related to and interpreting the object or text.

### BACKGROUND

People traveling to new and unknown areas may encounter many obstacles, both during the planning stage and during the actual trip itself. The personal computer has alleviated some of the problems faced by travelers. For example in the planning stage, a traveler can use the internet or a software program to book an airline flight, reserve lodging, rent an automobile, retrieve information on points of interest, etc. with just a few clicks of the computer's mouse. For travelers going to a foreign country, software programs are available to translate foreign languages, calculate exchange rates, and provide detailed travel maps, among others. Because of the personal computer's utility, it is desirable for a traveler to have access to various information services during the trip to solve problems that were unforeseeable during the planning stage.

Desk-top computers, however, are too cumbersome and laptop computers, although somewhat portable, are often bulky and heavy. Additionally, most personal computers systems are expensive. Thus, a traveler may be reluctant to travel with a computer system because of the increased weight and bulk, the risk of theft, and the risk of damage occurring to the computer, among others.

A possible solution, however, is a personal digital assistant (PDA). A PDA is a handheld computing device. Typically PDAs operate on a Microsoft Windows® based or a Palm® based operating system. The capabilities of PDAs have increased dramatically over the past few years. Originally used as a substitute for an address and appointment book, the latest PDAs are capable of running word processing and spreadsheets programs, receiving emails, and accessing the internet. In addition, most PDAs are capable of linking to other computer systems, such as a desk-tops and laptops.

Several characteristics make PDAs attractive as a travel aid. First, PDAs are small. Typical PDAs weigh mere ounces and fit easily into a user's hand. Second, PDAs use little power. Some PDAs use rechargeable batteries; others use readily available alkaline batteries. Next, PDAs are expandable and adaptable, for example, additional memory capacity can be added to a PDA and peripheral devices can be connected to a PDA's input/output ports, among others. Finally, PDAs are affordable. Typical PDAs range in price from $100 to $600 dollars depending on the features and functions of the device.

A common problem a traveler faces is the existence of a language barrier. The language barrier often renders important signs and notices useless to the traveler. For example, traffic, warning, and notification signs, street signs (among others) cannot convey the desired information to the traveler if the traveler cannot understand the sign's language or even the characters in which they are written. Thus, the traveler is subjected to otherwise avoidable risks.

Travel aids, such as language-to-language dictionaries and electronic translation devices, are of limited assistance because they are cumbersome, time-consuming to use, and often ineffective. For example, a traveler using an electronic translation device must manually enter the desired characters into the device. The traveler must pay special attention when entering the characters, or an incorrect result will be returned. When the language or even the characters (e.g., Chinese, Russian, Japanese, Arabic . . . ) are unknown to the user, data entry or even manual dictionary lookup become a serious challenge. While useful in other respects, PDAs in their common usage are of little help in dealing with language barriers.

Accordingly, a need exists for a portable information system that is capable of capturing, identifying, recognizing and translating signs that are written in a language foreign to a user.

In addition to the ability to translate signs, it is important for the traveler to know his position relative to some landmark and to identify objects in his/her environment. Daily navigation is typically accomplished using familiar landmarks as navigational waypoints. A person may use a familiar building, bridge, or road sign as a waypoint for reaching a destination. For individuals traveling within a foreign area, however, pertinent landmarks are difficult to recognize. Maps, global positioning systems, and other guides offer basic assistance to the traveler, but such information sources are cumbersome, often inaccurate, may be limited to a specific geographical area, and lack the specificity necessary for easy navigation.

Accordingly, the need exits for a hand-held, portable object identification and information system that allows a user to select an object within visual range and retrieve information related to the selected object. Additionally, a need exists for a hand-held portable object identification and information system that can determine the user's location and update a database containing information related to landmarks within a predetermined radius of the user's location.

### SUMMARY OF THE INVENTION

The present invention is directed to a portable information system comprising an input device for capturing an image having a user-selected object and a background. A handheld computer is responsive to the input device and is programmed to: distinguish and extract the user-selected object from the background; compare the user-selected object to a database of objects; and output information about the user-selected object in response to the step of comparing. The invention is particularly useful for translating signs, identifying landmarks, and acting as a navigational aid. Those advantages and benefits, and others, will be apparent from the Detailed Description below.

### BRIEF DESCRIPTION OF THE DRAWINGS

To enable the present invention to be easily understood and readily practiced, the present invention will now be described for purposes of illustration and not limitation, in connection with the following figures. Unless otherwise noted, like components have been assigned similar numbering throughout the description.

FIG. 1 illustrates a portable information system according to an embodiment of the present invention.

FIG. 2 is a block diagram of the portable information system of FIG. 1 according to one embodiment of the present invention.

FIG. 3 illustrates an operational process for translating a sign according to an embodiment of the present invention.

FIG. 4 illustrates a detailed operational process for extracting a sign's characters from a background as discussed in FIG. 3 according to an embodiment of the present invention.

FIG. 5 illustrates an operational process for using a portable information system to provide information related to a user-selected object according to an embodiment of the present invention.

FIG. 6 illustrates an operational process for providing information related to a user-selected object selected from a video stream of images according to an embodiment of the present invention.

FIG. 7 illustrates a video camera which has been modified to incorporate the identification and translation capabilities of the present invention.

FIG. 8 illustrates a pair of glasses which has been modified to incorporate the identification and translation capabilities of the present invention.

FIG. 9 illustrates a cellular telephone with a built in camera to incorporate the identification and translation capabilities of the present invention.

### DETAILED DESCRIPTION

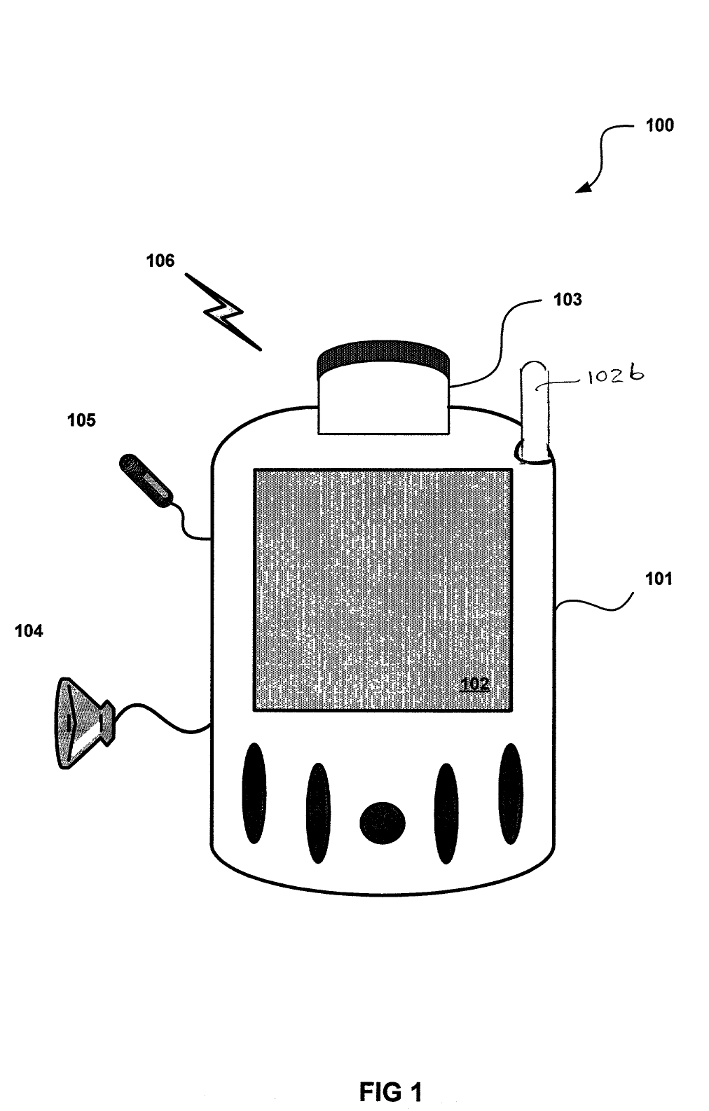

FIG. 1 illustrates a portable information system according to one embodiment of the present invention. Portable information system 100 includes a hand-held computer 101, a display 102 with pen-based input device 102b, a video input device 103, an audio output device 104, an audio input device 105, and a wireless signal input/output device 106, among others. Note, the stylus-type input capability is important for one embodiment of the present invention.

The hand-held computer 101 of the portable information system 100 includes a personal digital assistant (PDA) 101 which, in the currently preferred implementation, may be an HP Jornada Pocket PC®. Other current possible platforms include Handspring Visor®, a Palm® series PDA, Sony CLIE®, and Compaq iPAQ®, among others. The display output 102 is incorporated directly within the PDA 101, although a separate display output 102 may be used. For example, a headset display may be used which is connected to the PDA via an output jack or a wireless link. The display output 102 in the present embodiment is a touch screen which is also capable of receiving user input by way of a stylus, as is common for most PDA devices.

In the current embodiment, a digital camera 103 (i.e., the video input device) is directly attached to a dedicated port or to any port available on the PDA 101 (such as a PCI slot, PCMCIA slot, and USP port, among others). It should be noted that any video input device 103 can be used that is supported by the PDA 101. It should additionally be noted that the video input device 103 may be remotely connected to the PDA 101 by means of a cable or wireless link. Furthermore, in the current embodiment, the lens of digital camera 103 remains stationary relative to the PDA 101, although a lens that moves independently in relation to the PDA may also be employed.

In the current embodiment, a set of headphones 104 (i.e., the audio output device) are connected to the PDA 101 via an audio output jack (not shown) and a built in microphone or an external microphone 105 (i.e., the audio input device) is connected via an audio input jack (not shown). It should be noted that other audio output devices 104 and audio input devices 105 may be used while remaining within the scope of the present invention.

In the current embodiment, a digital communications transmitter/receiver 106 (i.e., wireless signal input/output device) is connected to a dedicated port, or to any port available on the PDA 101. Digital communications transmitter/receiver 106 is capable of transmitting and receiving voice and data signals, among others.

It should be noted that other types of wireless devices (such as a global positioning system (GPS) receiver and a cellular communications transmitter/receiver, among others) may be used in addition to, or substituted for the digital communications transmitter/receiver 106. It should further be noted that additional input or output devices may be employed by the portable information system 100 while remaining within the scope of the present invention.

In the current embodiment, the PDA 101 is responsive to the video camera 103 (among others). The PDA is operable to capture a picture, distinguish the textual segments from the image, extract the characters, recognize the characters and translate the sequence of characters contained within a video image. For example, a user points the video camera 103 and captures an image of a sign containing foreign text that he wishes to have translated into his/her own language. The PDA 101 is programmed to distinguish and extract the sign and the textual segment from the background, normalize and clean the characters, perform character recognition and translate the sign's character sequence into the user's language, and output the translation by way of the display 102 or verbally by way of the audio output device (among others). The PDA 101 is programmed to translate characters extracted from within a single video image, or track these characters from a moving continuous video stream. It should be noted that character refers to any letter, pictograph, numeral, symbol, punctuation, and mathematical symbol (among others), in any language used for communication. It should further be noted that sign refers to a group of one or more characters embedded in any visual scene.

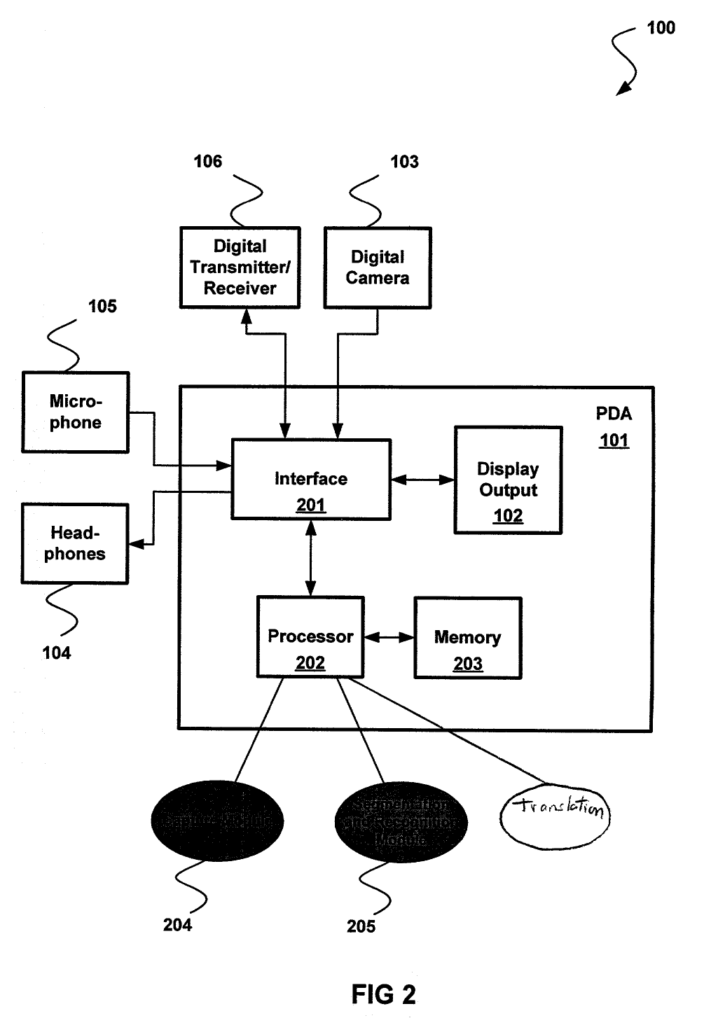

FIG. 2 is a block diagram of the portable information system 100 of FIG. 1 according to one embodiment of the present invention. The PDA 101 includes an interface module 201, a processor 202, and a memory 203. The interface module 201 provides information that is necessary for the correct functioning of the portable information system 100 to the user through the appropriate output device and from the user through the appropriate input device. For example, interface module 201 converts the various input signals (such as the input signals from the digital camera 103, the microphone 105, and the digital communication transmitter/receiver 106, among others) into input signals acceptable to the processor 202. Likewise, interface 201 converts various output signals from the processor 202 into output signals that are acceptable to the various output devices (such as output signals for the output display 102, the headphones 104, and the digital communication transmitter/receiver 106, among others).

In addition to executing the operating system of the PDA 101, processor 202 of the current embodiment executes the programming code necessary to distinguish and extract characters from the background, recognize these characters, translate the extracted characters, and return the translation to the user. Processor 202 is responsive to the various input devices and is operable to drive the output devices of the portable information system 100. Processor 202 is also operable (among others) to store and retrieve information from memory 203.

Capture module 204 and segmentation and recognition module 205 contain the programming code necessary for processor 202 to distinguish a character from a background and extract the characters from the background, among others. Capture module 204, segmentation and recognition module 205, and translation module 206 operate independent of each other and can be performed either onboard of the PDA as internal software or externally in a client/server arrangement. In one of these alternative embodiments, a single module that combines the functions of the capture module 204, the segmentation and recognition module 205, and the translation module 206, are all performed in on a fully integrated PDA device arrangement, while in another embodiment a picture is captured, and any of the steps, extraction/segmentation, recognition and translation, are performed externally on a server (see for example, the cell-phone embodiment described below). Either of these alternative embodiments remain within the scope of the present invention.

In one embodiment, portable information system 100 functions in the following manner. Interface module 201 receives a video input signal containing a user selected object such as a sign and a background from the digital camera 103 through one of the PDA's 101 input ports (such as a PCI card, PCMCIA card, and USP port, among others). If necessary, the interface module 201 converts the input signal to a form usable by the processor 202 and relays the video input signal to processor 202. The processor 202 stores the video input signal within memory 203 and executes the programming contained within the capture module 204, the segmentation and recognition module 205 and the translation module 206.

The capture module 204 contains programming which operates on a Windows® or Windows CE platform and supports directX® and Windows® video formats. The capture module 204 converts the video input signal into a video image signal that is returned to the processor 202 and sent to the segmentation and recognition module 205 and to the translation module 206. The video image signal may include a single image (for example, a digital photograph taken using the digital camera) or a video stream (for example, a plurality of images taken by a video recorder). It should be noted, however, that other platforms and other video formats may be used while remaining within the scope of the present invention.

The segmentation and recognition module 205 uses algorithms (such as edge filtering, texture segmentation, color quantization, and neural networks and bootstrapping, among others) to detect and extract objects from within the video image signal. The segmentation and recognition module 205 detects the objects from within the video image signal, extracts the objects, and returns the results to the processor 202. For example, the segmentation and recognition module 205 detects the location of a character sequence on a sign within the video image signal and returns an outlined region containing the character sequence to the processor 202.

In the current embodiment, the segmentation and recognition module 205 uses a three-layer, adaptive search strategy algorithm to detect signs within an image. The first layer of the adaptive search strategy algorithm uses a multi-resolution approach to initially detect possible sign regions within the image. For example, an edge detection algorithm employing varied scaled parameters is used; the result from each resolution is fused to obtain initial candidates (i.e., areas where signs are likely present within the image).

Next, the second layer performs an adaptive search. The adaptive search is constrained to the initial candidates selected by the first layer and by the signs' layout. More specifically, the second layer starts from the initial candidates, but the search directions and acceptance criteria are determined by taking traditional sign layout into account. The searching strategy and criteria under these constraints is referred to as the syntax of sign layout.

Finally, the third layer aligns the characters in an optimal way, such that characters belonging to the same sign will be aligned together. In the current embodiment, the selected sign is then sent to the processor 202.

Processor 202 outputs the results to the interface module 201, which if necessary, converts the signal into the appropriate format for the intended output device (for example, the output display 102). The user can then confirm that the region extracted by the segmentation and recognition module 205 contains the characters for which translation is desired, or the user can select another region containing different characters. For example, the user can select the extracted region by touching the appropriate area on the output display 102 or can select another region by drawing a box around the desired region. The interface module 201 converts the user input signal as needed and sends the user input signal to the processor 202.

After receiving the user's confirmation (or alternate selection), the processor 202 then prompts the segmentation and recognition module 205 to recognize and module 206 to translate any characters contained in the selected region. In the current embodiment, character recognition of Chinese characters is performed by module 205 and dictionary and phrase-book lookup is used to translate simple messages and a more complex glossary of word sequences and fragments is used in an example-based machine translation (EBMT) or statistical machine translation (SMT) framework to translate the text in the selected sign. It should be noted that a separate and/or external translation module may be utilized while remaining within the scope of the present invention.

The segmentation and recognition module 205 works in conjunction with memory 203. In the current embodiment, memory 203 includes a database with information related to the type of objects that are to be identified and the languages to be translated, among others. For example, the database may contain information related to the syntax and physical layout of signs used by a particular country, along with information related to the language that the sign is written in and related to the user's native language. Information may be output in several ways, e.g. visually, acoustically, or some combination of the two, e.g. a visual display of a translated sign together with a synthetically generated pronunciation of the original sign.

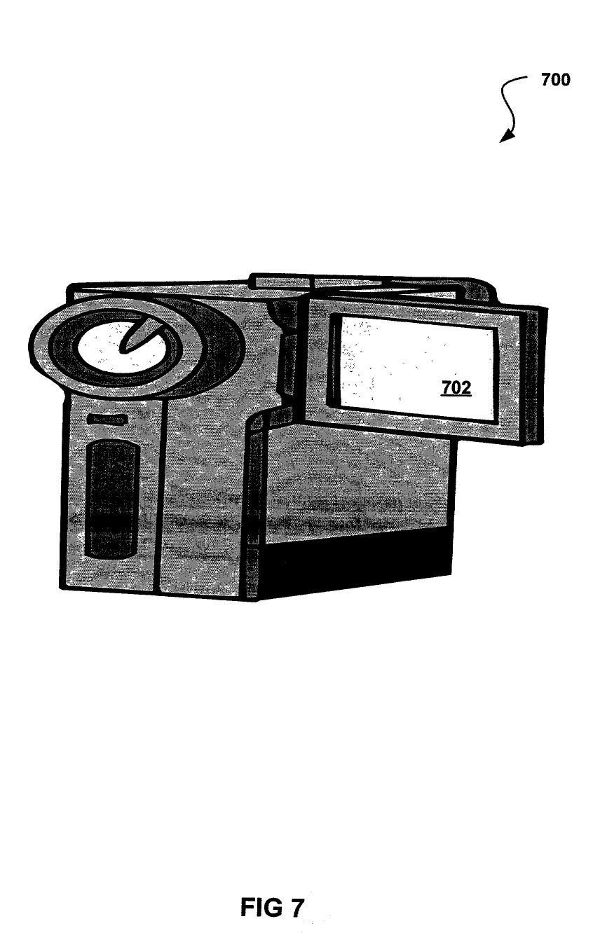

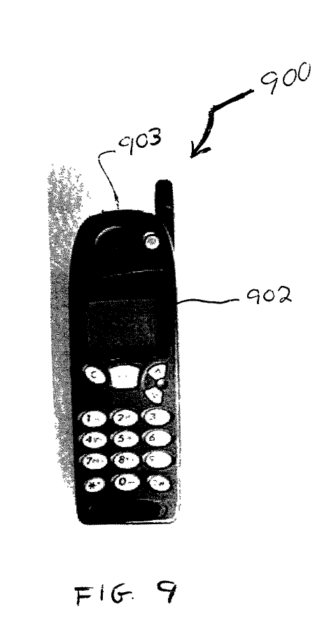

Alternative embodiments of the portable information system 100 are shown in FIGS. 7 and 9. FIG. 7 illustrates a video camera 700 while FIG. 9 illustrates a cell-phone 900 which have both been provided with the previously described programming such that the video camera and phone can provide the identification and translation capabilities described in conjunction with the portable information system 100. Cell-phone 900 has been provided with a camera (not shown) on the back side 903 of the phone. In these embodiments, the camera 700 or camera in the cell-phone 900 is pointed at a sign by the user (potentially also exploiting the built in zoom capability of the camera 700). Selection of the character sequence or objects of interest in the scene is once again performed either automatically or by user selection, using a touch sensitive screen 702 or 902, a viewfinder in the case of the camera, or a user-controllable cursor. Character extraction (or object segmentation), recognition and translation (or interpretation) are then performed as before and the resulting image shown on the viewfinder or screen 702 or 902, which may include the desired translation or interpretation as a caption under the object.

In FIG. 9, a client server embodiment may be implemented. The cell-phone 900 sends an image to a server via the phone's connection, and receives the result (interpretation, translation, info-retrieval, etc.). Display of the result could be on the cell phone display or by speech over the phone, or both.

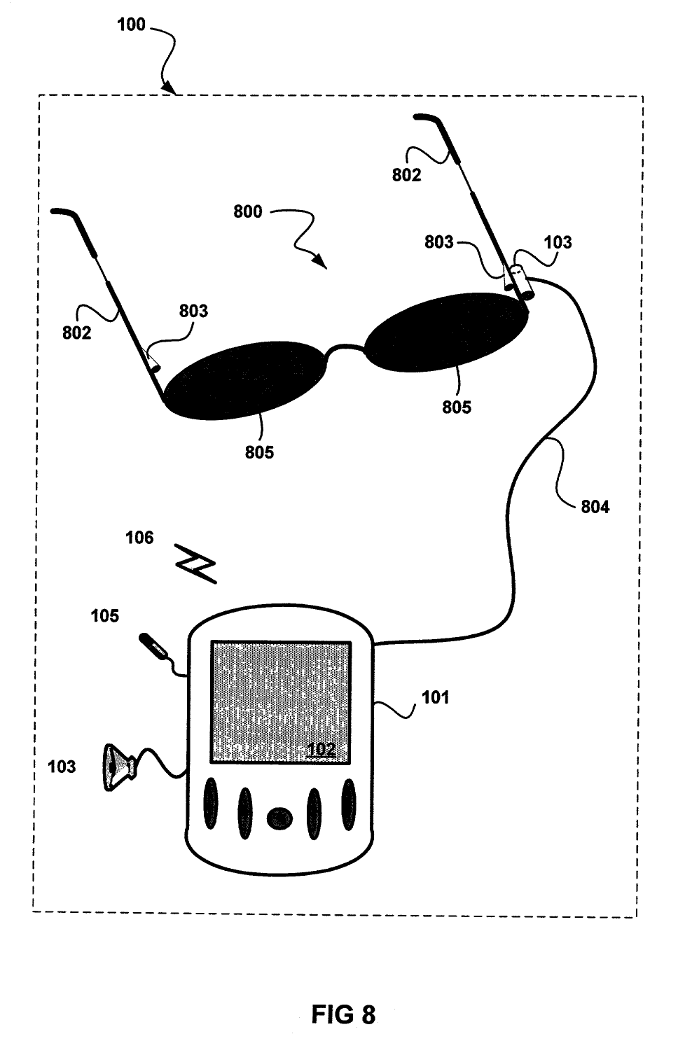

Yet another alternative embodiment of the portable information system 100 is shown in FIG. 8. FIG. 8 illustrates a portable information system 100 including a pair of glasses 800 or other eyewear, e.g. goggles, connected to a hand-held computer 101 having the previously described programming such that the pair of glasses 800 can provide the identification and translation capabilities described in conjunction with the portable information system 100. The pair of glasses 800 are worn by the user, and a video input device 103 is secured to the stem 802 of the glasses 801 such that a video input image, corresponding to the view seen by a user wearing the pair of glasses 800, is captured. The video input device communicates with a hand-held computer 101 via wire 804 or wireless link. A projection device 803, also attached to the stem of glasses 801, displays information to the user on the lenses 805 of the pair of glasses 800.

It should be noted that other configurations of the portable information system 100 may be used while remaining within the scope of the present invention. For example, a pair of goggles or helmet display may be substituted for the pair of glasses 800 and an audio output device (such as a pair of headphones) may be attached or otherwise incorporated with the pair of glasses 800. It should further be noted that lenses 805 capable of displaying the information (such as through the use of LCD technology), without the need for a projection device 803, are within the scope of the present invention.

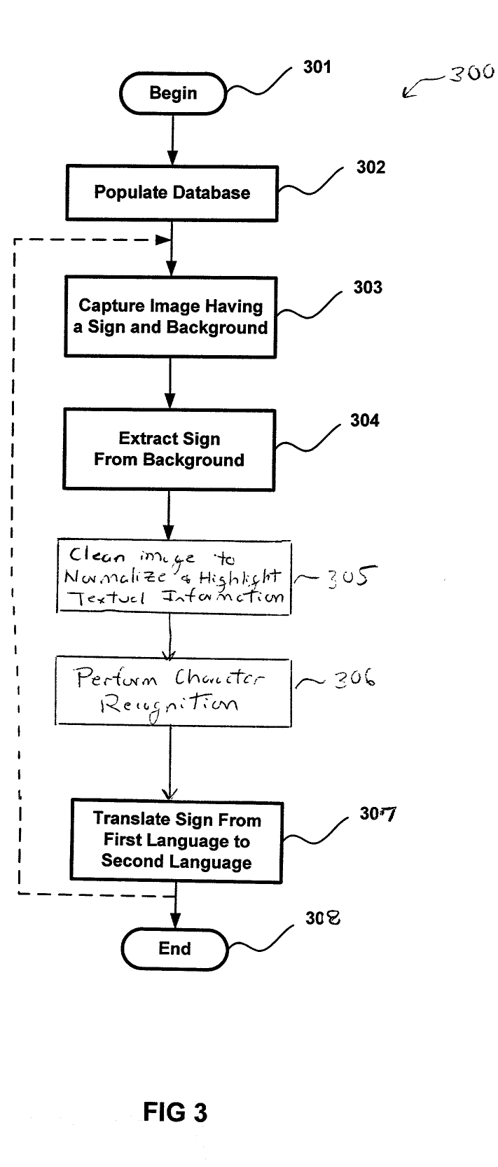

FIG. 3 illustrates an operational process 300 for translating a sign according to an embodiment of the present invention. Operation 301, which initiates operational process 300, can be manually implemented by the user or automatically implemented, for example, when the PDA 101 is turned on.

After operational process 300 is initiated by operation 301, operation 302 populates the database within the PDA 101. The database is populated by downloading information using a personal computer system, the internet, and a wireless signal, among others. Alternatively, the database can be populated using a memory card containing the desired information.

After the database is populated in operation 302, operation 303 captures an image having a sign and a background. In the current embodiment, the user points the camera 103 connected to or incorporated into the PDA 101 at a scene containing the sign, that the user wishes to translate. The user then operates the camera 103 to collect the scene (i.e., takes a snapshot or presses record if the camera 103 is a video camera) and creates a video input signal. The video input signal is sent to capture module 204 as discussed in conjunction with FIG. 2.

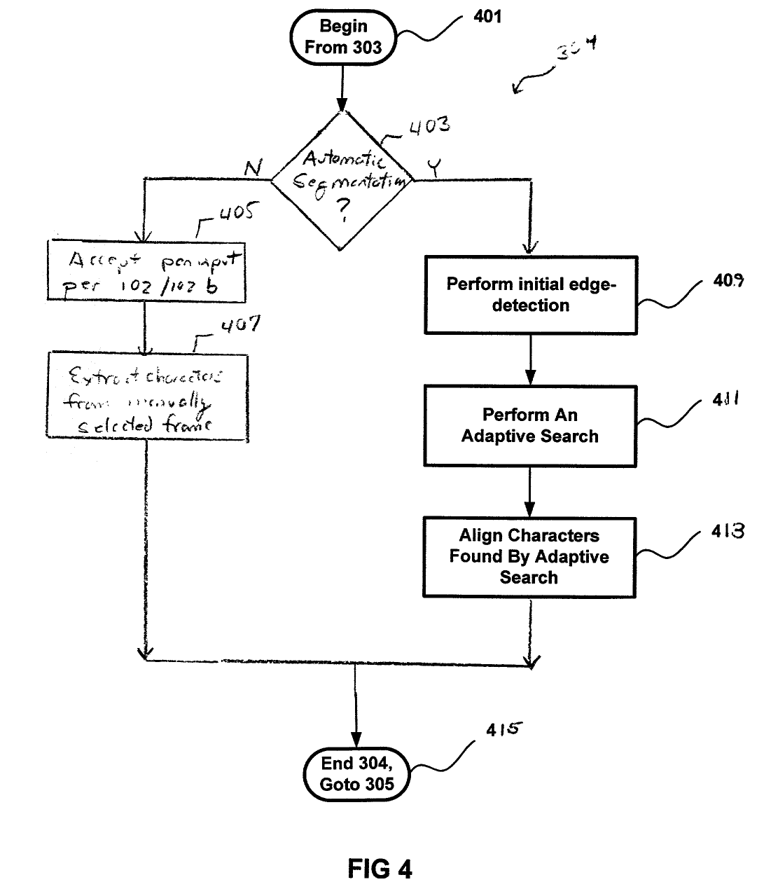

Operation 304 extracts the sign from the scene's background. In the current embodiment, operation 304 employs a segmentation and recognition module 205 to extract the sign from the background. In particular, the segmentation and recognition module 205 used by operation 304 employs a three-layered, adaptive search strategy algorithm, as discussed in conjunction with FIG. 2 and FIG. 4, to detect a sign, or the characters of a sign, within an image. In the current embodiment, the user can then confirm the selection of the segmentation and recognition module 205 or select another sign within the image.

After operation 304 extracts the sign from the background, or as part of the extraction operation, the image is cleaned (filtered) to normalize and highlight textual information at step 305. Operation 306 performs optical character recognition. In the current embodiment, recognition of more than 3,000 Chinese characters is performed. In the current embodiment, a template matching approach is used for recognition. It should be noted, however, that other recognition techniques and character sets other than Chinese or English may be used while remaining within the scope of the present invention.

After operation 306 recognizes the character sequence in the sign, operation 307 translates the sign from the first language to a second language. In the current embodiment, operation 306 employs an example-based machine translation (EBMT) technique, as discussed in conjunction with FIG. 2, to translate the recognized characters. It should be noted, however, that other translation techniques may be used while remaining within the scope of the present invention.

It should also be noted that a user can obtain a translation for a specific portion of a sign by selecting only any part of the sign for translation. For example, a user may select the single word “yield” to be translated from a sign reading “yield to oncoming traffic.” After the sign has been translated by operation 307, operation 308 terminates operational procedure 300.

FIG. 4 illustrates a detailed operational process for operation 304 as discussed in FIG. 3 according to an embodiment of the present invention. As discussed in conjunction with operational process 300, operation 304 extracts the sign from the seene's background after operation 303 captures the scene containing the sign that the user wishes to have translated. As previously discussed, sign refers to a group of one or more characters and character refers to any letter, pictograph, numeral, symbol, punctuation, and mathematical symbol (among others), in any language used for communication.

As illustrated in FIG. 4, operation 401 initiates operation 304 after operation 303 is completed. The first step is a decision step 403 in which a determination is made if the segmentation is to be automatically performed. If no, then the segmentation will be performed manually. In the described embodiment, the segmentation will be performed with the pen 102b and display 102 as shown by step 405. After the segment has been identified, characters are extracted from the manually selected frame at step 407. The process then ends at step 415.

If, at step 403, the segmentation is to be performed automatically, the process proceeds with operation 409. Operation 409 performs an initial edge-detection algorithm and stores the result in the memory 203. In the current embodiment, operation 409 uses an edge-detection algorithm that employs a multi-resolution approach to initially detect possible sign regions within the image. For example, an edge detection algorithm employing varied scaled parameters is used; the result from each resolution is fused to obtain initial candidates (i.e., areas where signs are likely present within the image).

After operation 409 performs the initial edge detection algorithm, operation 411 performs an adaptive search. In the current embodiment, the adaptive search performed by operation 411 is constrained to the initial candidates selected by operation 409 and by the signs' layout. More specifically, the adaptive search of operation 411 starts at the initial candidates from operation 409, but the search directions and acceptance criteria are determined by taking traditional sign layout into account. The searching strategy and criteria under these constraints is referred to as the syntax of sign layout.

Operation 413 then aligns the characters found in operation 411 in their optimal form, such that characters belonging to the same sign will be aligned together. In the current embodiment, operation 413 employs a program that takes into account the common, various sign layouts used in a particular country or region. For example, in China, the characters in a sign are commonly written both horizontally and vertically. Operation 413 takes that fact into account when aligning the characters found in operation 411. After operation 413 aligns the characters, operation 415 terminates operation 304 and passes any results along to operation 305.

In an alternative embodiment, the portable information system 100 functions as a portable object identification system for selecting an object and returning related information to the user. Information related to objects encountered while traveling (such as buildings, monuments, bridges, tunnels, roads, etc.) may be stored within the database. For example, a tourist traveling to Washington, D.C. may populate the database with information related to objects such as the Washington Monument, the White House, and the U.S. Capital Building, among others.

In an alternative embodiment, the portable information system 100 functions as a portable person identification system for selecting a person's face and returning related information about that person to the user. The database includes facial image samples and information related to that person (such as person's name, address, family status and relatives, favorite foods, hobbies, likes/dislikes, etc.).

The user downloads information into the database using a personal computer system, the internet, and a wireless signal (among others), prior to traveling to a particular location. Alternatively, a memory card containing the relevant information may be inserted into an expansion port of the PDA 101. The size of the database, and the amount of information stored therein, is limited only by the capabilities of the PDA 101.

The user may also populate or update the database depending on location after arriving at the destination. In the current embodiment, a GPS system 106 (see FIG. 1) determines the exact location of the portable information system 100. Next, the portable information system 100 requests information based upon the positioning information provided by the GPS system 106. For example, portable information system 100 requests information via the digital communication transmitter/receiver 106. The applicable information is then downloaded into the database via the digital communication transmitter/receiver 106.

After populating the database, the user points the digital camera 103 towards an object to be identified (for example, a building) and records the scene. For example, while in Washington D.C., the user points the digital camera 103 and records a scene containing the Washington Monument and its reflecting pool, along with various other monuments. The video input signal is sent from the digital camera 103, through the interface module 201, to the processor 202. The processor 202 archives the video input signal within memory 203 and sends the image to the capture module 204. The capture module 204 converts the video input signal into a video image signal and sends the video image signal to the processor 202 and the segmentation and recognition module 205.

The segmentation and recognition module 205 extracts both the Washington Monument and the reflecting pool, among others, from the video image signal. The user is then prompted, on display output 102, to select which object is to be identified. Using an input device (for example, a keypad, pointing device, etc.), the user selects the Washington Monument. The processor 202 then accesses the database within memory 203 to match the selected object to an object within the database. The information related to the Washington Monument (for example, height, date completed, location relative to other landmarks, etc.) is then retrieved from the database and returned to the user.

In an alternative embodiment, the user directs a video camera towards the object that is to be identified and continuously records other scenes. The video camera records a video stream (i.e., the video input signal) that is sent to the processor 202. The processor 202 stores the video stream within the memory 203 and sends the video stream to the capture module 204. The capture module 204 converts the video stream into a video image signal and sends the video image signal to the processor 202 and the segmentation and recognition module 205. In this embodiment, the user has the option to immediately select the object for identification, or continue recording other objects and later return to a specific object for identification.

For example, while in Washington D.C., the user continuously records a video stream containing the Washington Monument and its reflecting pool, along with other various other monuments, with the video recorder. The video stream is archived within memory 203. Later, the user scrolls through the video stream archive and selects and image containing the Washington Monument, its reflecting pool, and the background. The segmentation and recognition module 205 extracts both the Washington Monument and its reflecting pool from the image. The user is then prompted, via display output 102, to select which object is to be identified. Using an input device (for example, a keypad, pointing device, etc.), the user selects the Washington Monument. As discussed above, information related to the Washington Monument is returned to he user.

It should be noted, however, that the discussion of the invention in terms of tourist information is not intended to limit the invention to the disclosed embodiment. For example, the portable information system 100 can be used to identify objects related to sailing (such as ship type, port information, astrology charts, etc.), objects related to military operations (such as weapon system type, aircraft type, armor vehicle type, etc.), and objects related to security systems (such as faces), among others. The specific use of the portable information system 100 may be altered by populating the database 203 with information related to that specific use, among others.

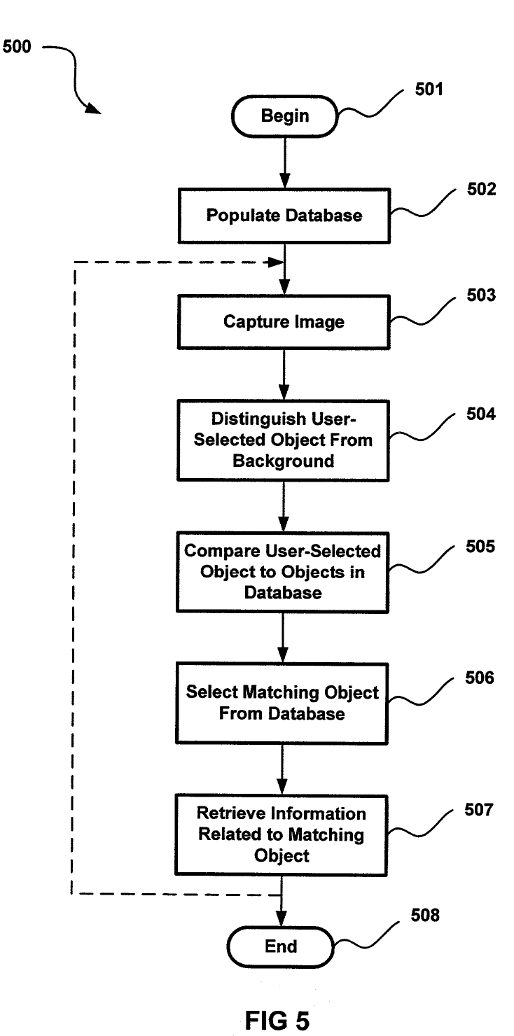

FIG. 5 illustrates an operational process 500 for using a hand-held computer to provide information related to a user-selected object according to an embodiment of the present invention. Operation 501, which initiates operational process 500, can be manually implemented by the user or automatically implemented, for example, when the PDA 100 is turned on.

After operational process 500 is initiated, operation 502 populates the database with relevant information. In the current embodiment, the hand-held computer is a PDA 101. The database 203 is populated by downloading information using a computer system, the internet, and a wireless system, among others. For example, during the planning stages of the journey, a user traveling to Washington D.C. may populate the database 203 with maps and information related to the monuments located in the city.

Additionally, the database 203 can be populated or updated automatically. First, the relative position of the PDA 101 is determined using a GPS system (see description of FIG. 1) contained within the PDA 101. Once the position of the PDA 101 is determined, the database 203 is populated or updated using a wireless communication system 106. For example, if the GPS determines that the PDA 101 is positioned in the city of Washington, D.C., information related to Washington D.C. is downloaded into the database 203.

After the database is populated by operation 502, operation 503 captures an image having an object and a background. In the current embodiment, the user points the camera 103 connected to or incorporated into the PDA 101 at a scene containing an object (such as a monument or building) for which the user wishes to obtain more information. The user then operates the camera 103 to collect the scene (i.e., takes a snapshot or presses record if the camera 103 is a video camera) and creates a video input signal. The video input signal is sent to capture module 204 as discussed in conjunction with FIG. 2.

Operation 504 distinguishes objects within the image from the background of the image. In the current embodiment, operation 504 may use a segmentation and recognition module 205 as discussed in conjunction with FIG. 2 to distinguish objects from the background. For example, operation 504 distinguishes a building from the surrounding skyline. In the current embodiment, the object that is closest to the center of the display 102 (which is referred to as the active area) is automatically selected as the desired object for the user. In an alternative embodiment, the user is given an opportunity to confirm, or alter, the automatic selection.

After the user-selected object is distinguished in operation 504, operation 505 compares the user-selected object to objects that were added to the database by operation 502. In the current embodiment, the processor 202 of the PDA 101 is programmed to compare the user-selected object to the objects within the database 203 as discussed in conjunction with FIG. 2.

Operation 506 selects a matching object from the database after the user-selected object is compared to the database entries in operation 505. In the current embodiment the processor 202 of the PDA 101 is programmed to select the matching object from the database 203 as discussed in conjunction with FIG. 2.

After operation 506 selects a matching object, operation 507 retrieves information related to the matching object from the database. In the current embodiment, the processor 202 is programmed to retrieve the information related to matching object from within the database 203 as discussed in conjunction with FIG. 2. For example, processor 202 retrieves information regarding the monuments name, when it was constructed, its dimensions, etc. from the database 203. After operation 507 retrieves the appropriate information, operational process 500 is terminated by operation 508 or, as shown by the broken line, the process may return to process 503 if another image is to be captured.

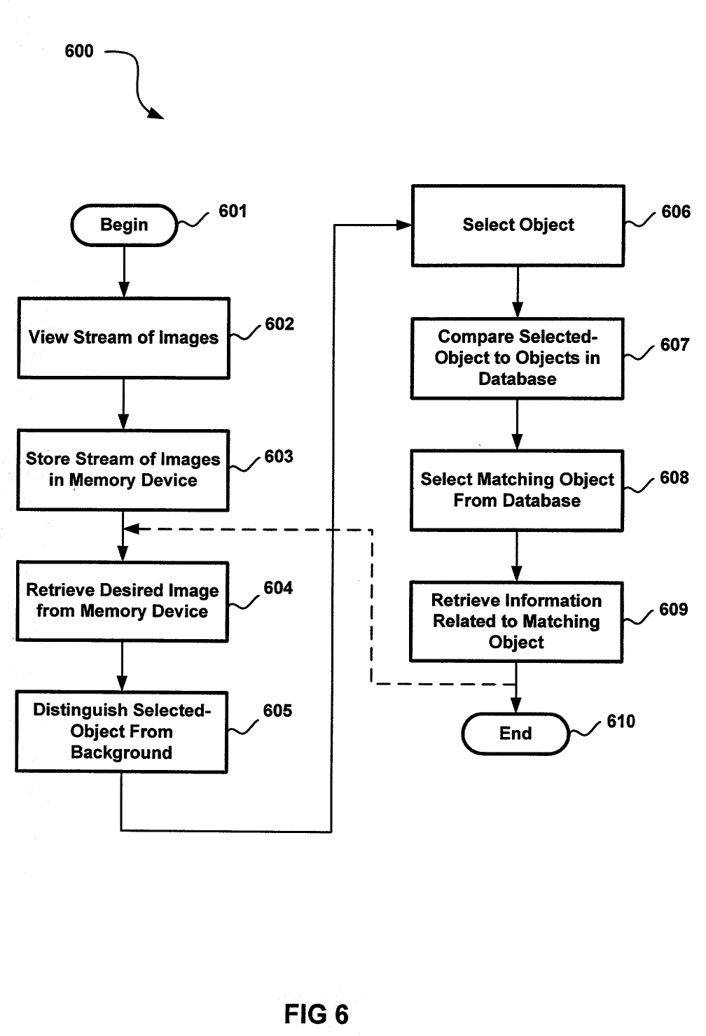

FIG. 6 illustrates an operational process 600 for using the hand-held computer 101 to provide information related to a user-selected object selected from a video stream of images according to an embodiment of the present invention. This is useful to extract objects or text in moving scenes (e.g. when driving by), or when precise positioning and image capture at a given moment is not possible. It also helps extract or reconstruct a stable unocluded image.

Operation 600 is initiated by operation 601. Operation 601 can be manually implemented by the user or automatically implemented, for example, when the hand-held computer is turned on. In the current embodiment, as discussed in conjunction with FIG. 3, the database 203 of PDA 101 is populated and updated prior to beginning operation 602.

After operation 601 implements operational process 600, operation 602 views a stream of video from a video input device attached to or contained within the hand-held computer. In the current embodiment, the hand-held computer is the PDA 101 and the video input device is the video camera 103.

After the video stream is viewed in operation 602, operation 603 stores the video stream in the memory of the hand-held computer. In the current embodiment, the video stream is stored in the PDA's memory 203 as a video input signal as discussed in conjunction with FIG. 2.

Operation 604 retrieves the desired portion of the video stream from the memory. In the current embodiment, the user can scroll through (i.e., preview) the video input signal that was saved in the PDA's memory 203 by operation 603. Once the desired object is found within the video input signal, that portion of the video input signal is retrieved and sent to the capture module 204 as discussed in conjunction with FIG. 2.

Operation 605 distinguishes the objects within the portion of the video input signal retrieved in operation 604. In the current embodiment, operation 605 employs a segmentation and recognition module 205, as discussed in conjunction with FIG. 2, to distinguish the objects within the portion of the video input signal.

Operation 606 selects an object that was distinguished from the background in operation 605. In the current embodiment, the user is able to confirm a selection made by the segmentation and recognition module 205, or select another object by pointing to the desired object while displayed on a touch sensitive screen 102. It should be noted that other methods of selecting the object may be used while remaining within the scope of the present invention.

Operation 607 compares the object selected in operation 606 to objects contained in the database. In the current embodiment, the PDA's processor 202 is programmed to compare the user-selected object to the objects within the database 203 as discussed in conjunction with FIG. 2.

Operation 608 selects a matching object from the database after the selected object is compared to the database entries in operation 607. In the current embodiment the processor 202 of the PDA 101 is programmed to select the matching object from the database 203 as discussed in conjunction with FIG. 2.

After operation 608 selects a matching object, operation 609 retrieves information related to the matching object from the database which is then output to the user. In the current embodiment, the processor 202 is programmed to retrieve the information related to matching object from within the database 203 as discussed in conjunction with FIG. 2. After the information retrieved by operation 609 is output, operational process 600 is terminated by operation 610 unless another image is to be retrieved as shown by the broken line.

The above-described embodiments of the invention are intended to be illustrative only. Numerous alternative embodiments may be devised by those skilled in the art without departing from the scope of the following claims. For example, other types of segmentation and recognition algorithms may be used, other types of translation algorithms may be used, and the concepts of the present invention may be incorporated into other types of electronic devices without departing from the present invention which is limited only by the following claims.

What is claimed is:

1. A portable information system, comprising:
an input device for capturing an image having a user-selected object and a background; and
a hand-held computer responsive to said input device and programmed to:
distinguish said user-selected object from said background;
compare said user-selected object to a database of objects; and
output information about said user-selected object in response to said step of comparing.

2. The portable information system of claim 1 wherein said input device includes one of a camera and a scanner.

3. The portable information system of claim 1 wherein said hand-held computer includes a personal digital assistant.

4. The portable information system of claim 1 wherein said hand-held computer comprises an output device for displaying said captured image and wherein said hand-held computer is programmed to operate in a continuous mode based on said user-selected object being positioned within an active area of said output device.

5. The portable information system of claim 1 wherein said hand-held computer comprises a touch sensitive output device for displaying said captured image, and wherein said hand-held computer is programmed to operate based on the user-selected object being one of touched or outlined.

6. A portable translation system, comprising:
an input device for capturing an image including text and a background; and
a hand-held computer responsive to said input device and programmed to:
distinguish text in said sign from said background;
recognize characters forming the text;
translate said text; and
output a translation of said text.

7. The portable translation system of claim 6 wherein said output includes one of acoustic and visual output.

8. The portable system of claim 7 wherein said acoustic output includes speech synthesis.

9. The portable system of claim 8 additionally comprising outputting said translation visually and outputting said recognized characters acoustically.

10. The portable translation system of claim 6 wherein said input device includes one of a camera and a scanner.

11. The portable translation system of claim 6 wherein said handheld computer includes a personal digital assistant.

12. The portable translation system of claim 6 wherein said hand-held computer comprises an output device for displaying said captured image and wherein said hand-held computer is programmed to continuously translate characters positioned within an active area of said output device.

13. The portable translation system of claim 6 wherein said hand-held computer comprises a touch sensitive output device for displaying said captured image, and wherein said hand-held computer is programmed to operate based on characters being one of touched or outlined.

14. A portable system, comprising:
an input device for capturing an image including text and a background; and
a hand-held computer responsive to said input device and programmed to:
distinguish text in said sign from said background;
recognize characters forming the text;
convert said characters into a different set of characters; and
output said different set of characters.

15. The portable system of claim 14 wherein said output includes one of acoustic and visual output.

16. The portable system of claim 15 wherein said acoustic output includes speech synthesis.

17. The portable system of claim 14 additionally comprising outputting said different set of characters visually and outputting said recognized characters acoustically.

18. The portable system of claim 14 wherein said input device includes one of a camera and a scanner.

19. The portable system of claim 14 wherein said handheld computer includes a personal digital assistant.

20. The portable system of claim 14 wherein said hand-held computer comprises an output device for displaying said captured image and wherein said hand-held computer is programmed to continuously convert characters positioned within an active area of said output device.

21. The portable system of claim 14 wherein said hand-held computer comprises a touch sensitive output device for displaying said captured image, and wherein said hand-held computer is programmed to operate based on the characters of the sign being one of touched or outlined.

22. A video camera for producing an image having at least one object and a background, the improvement comprising:
a computer having a processor and memory, said computer programmed to:
extract said at least one object from said background;
compare said at least one object to a database of objects; and
output information about said at least one object in response to said step of comparing.

23. The camera of claim 22 additionally comprising a screen for displaying said produced image, and wherein said computer is programmed to operate based on the object being positioned within some portion of said screen.

24. The camera of claim 22 wherein said information output about said at least one object is selected from the set comprising a translation, a conversion, historical information, biographical information, and geographical information.

25. A cell phone having a camera for producing an image having at least one object and a background, the improvement comprising:
a computer having a processor and memory, said computer programmed to:
extract said at least one object from said background;
compare said at least one object to a database of objects; and
output information about said at least one object in response to said step of comparing.

26. The cell phone of claim 25 additionally comprising an output screen for displaying said produced image and wherein said computer is programmed to operate in a continuous mode based on said at least one object being positioned within an active area of said output screen.

27. The cell phone of claim 25 additionally comprising a touch sensitive output screen for displaying said produced image, and wherein said computer is programmed to operate based on the object being one of touched or outlined.

28. The cell phone of claim 25 wherein said information output about said at least one object is selected from the set comprising a translation, a conversion, historical information, biographical information, and geographical information.

29. The cell phone of claim 25 wherein said computer is provided by a server, and wherein said cell phone is in communication with said server.

30. A combination, comprising:
eyewear;
an input device carried by said eyewear for capturing an image having an object and a background; and
a hand-held computer responsive to said input device and programmed to:
extract said at least one object from said background;
compare said at least one object to a database of objects; and
output information about said at least one object in response to said step of comparing.

31. The combination of claim 30 additionally comprising an output device for displaying said captured image and wherein said computer is programmed to operate in a continuous mode based on said at least one object being positioned within an active area of said output device.

32. The combination of claim 30 additionally comprising a touch sensitive output screen for displaying said produced image, and wherein said computer is programmed to operate based on the object being one of touched or outlined.

33. The combination of claim 30 wherein said information output about said at least one object is selected from the set comprising a translation, a conversion, historical information, biographical information, and geographical information.

34. A method for using a hand-held computer to provide information related to a user-selected object, comprising:
populating a database within a hand-held computer with a plurality of objects and information related thereto;
capturing an image having a user-selected object and a background;
distinguishing said user-selected object from said background;
comparing said user-selected object to said plurality of objects;
selecting an object matching said user-selected object from said plurality of objects; and
retrieving and outputting information in response to said selecting step.

35. The method of claim 34 additionally comprising determining said hand-held computer's relative location and populating the data based on the computer's relative location.

36. The method of claim 34 wherein said capturing an image includes storing said image in a memory device.

37. The method of claim 34 wherein said capturing an image includes storing a stream of images.

38. The method of claim 34 wherein said distinguishing said user-selected object from said background further comprises:
employing at least one of edge filtering, neural networks and bootstrapping, texture segmentation, and color quantization.

39. The method of claim 34 wherein said distinguishing said user-selected object from said background further comprises manually designating said user-selected object within said image.

40. A method for translating a sign having a plurality of characters in a first language to a second language, comprising:
capturing an image containing a background and a sign;
extracting a plurality of characters from said sign;
recognizing said plurality of characters; and
translating said plurality of characters from a first language to a second language.

41. The method of claim 40 wherein said capturing an image includes storing said image in a memory device.

42. The method of claim 40 wherein said capturing an image containing a background and a sign further comprises storing a stream of images in a memory device.

43. The method of claim 40 wherein said extracting said plurality of characters from said background further comprises manually designating said characters within said image.

44. The method of claim 40 wherein said extracting said plurality of characters further comprises:
employing at least one of edge filtering, neural networks and bootstrapping, texture segmentation, and color quantization.

45. The method of claim 40 wherein said translating said plurality of characters from said first language to said second language further comprises employing one of an example based system, rule-based system, statistical machine translation system, a phrase-book, and a lookup dictionary.
